(19) United States
(12) Patent Application Publication
(10) Pub. No.: US 2018/0141309 A1
(43) Pub. Date: May 24, 2018

(54) DECORATION OF A METALLIC APPEARANCE FOR ARTICLE AND METHOD FOR MANUFACTURING THE SAME

(71) Applicant: HON HAI PRECISION INDUSTRY CO., LTD., New Taipei (TW)

(72) Inventors: FENG-YUEN DAI, Tu-Cheng (TW); JIH-CHEN LIU, New Taipei (TW); CHIH-JUNG CHANG, New Taipei (TW); HUNG-CHUN MA, New Taipei (TW); YU-LIN LIAO, New Taipei (TW); YI-ZHONG SHEU, New Taipei (TW); HAN-LUNG CHAO, New Taipei (TW); JAN-WAN CHANG, New Taipei (TW); WEI-TING CHEN, New Taipei (TW); CHEN-CHU CHIANG, New Taipei (TW)

(21) Appl. No.: 15/627,638

(22) Filed: Jun. 20, 2017

(30) Foreign Application Priority Data
Nov. 21, 2016 (CN) 201611042799.6

(51) Int. Cl. B32B 15/04; B32B 38/00

(52) U.S. Cl. CPC B32B 15/04; B32B 2451/00; B32B 2307/412; B32B 38/145

(57) ABSTRACT

A method for manufacturing an imitation metallic decoration on an article includes providing a base layer with a first surface, applying a texture layer on the first surface; the texture layer including a second surface facing away from the first surface, and applying a complete metallic ink layer on the second surface. Hereby, a plastic article can be given a metallic appearance to match that, for example, of an actual metal used as another cover of the article.

### FIELD

The subject matter generally relates to a decorative finishes, and more particularly, to a decoration of a metallic appearance for article and a method for manufacturing the decoration.

### BACKGROUND

Mobile phones usually include metallic back covers and antennas received in the metallic back covers. To prevent the metallic back cover from interfering with signals emitted by the antenna, a plastic portion is formed in the metallic back cover by insert molding. The plastic portion is usually coated with a stoving varnish with metal appearance to bring the plastic portion and the metallic back cover to have similar colors. However, the stoving varnish cannot form metallic textures to match the appearance of the metallic back cover. Improvements in the art is preferred.

### BRIEF DESCRIPTION OF THE DRAWINGS

Implementations of the present technology will now be described, by way of example only, with reference to the attached figures.

FIG. 1 is a cross-sectional view of an exemplary embodiment of a decoration of a metallic appearance for article, of the present disclosure.

FIG. 2 is a flowchart for manufacturing the decoration of FIG. 1.

FIG. 3 is a cross-sectional view of a base layer used in the method of FIG. 2.

FIG. 4 is a cross-sectional view of a texture layer formed on the base layer of FIG. 3.

FIG. 5 is a cross-sectional view of a metallic ink layer formed on the texture layer of FIG. 4.

### DETAILED DESCRIPTION OF EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

The term “comprising,” when utilized, means “including, but not necessarily limited to”; it specifically indicates open-ended inclusion or membership in the so-described combination, group, series, and the like.

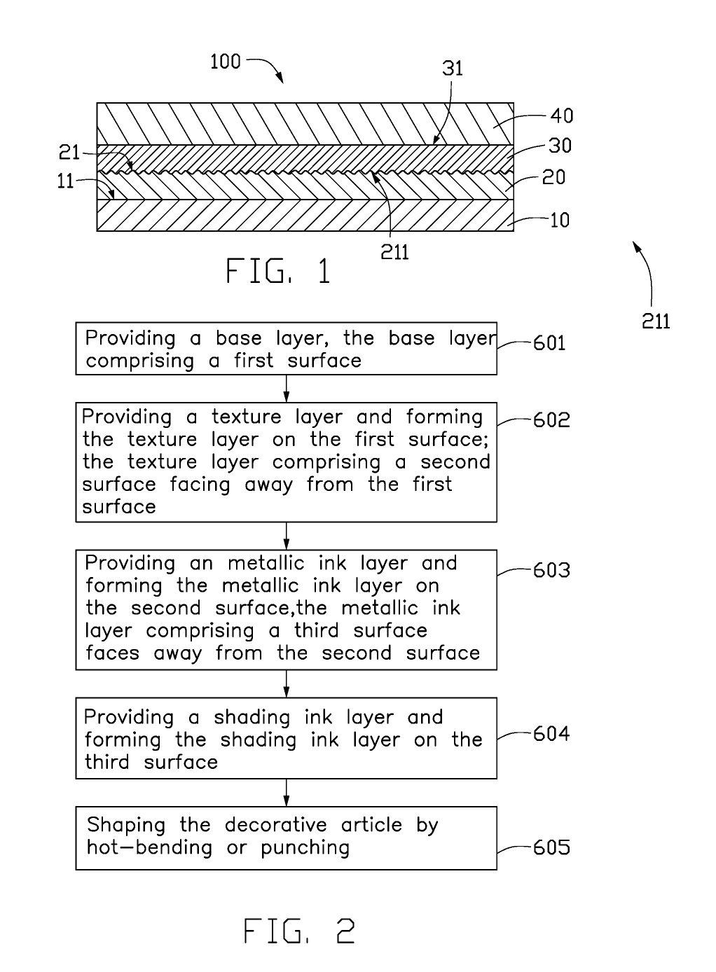

FIG. 1 illustrates an exemplary embodiment of a decoration of a metallic appearance 100 for article. The decoration of a metallic appearance 100 can be applied on a back cover of an electronic device (such as a mobile phone, not shown). The decoration of a metallic appearance 100 includes a transparent base layer 10, a texture layer 20, a metallic ink layer 30, and a shading ink layer 40 stacked together.

The base layer 10 includes a first surface 11. The texture layer 20 is formed on the first surface 111.

The texture layer 20 includes a second surface 21. The second surface 21 faces away from the first surface 11. A number of textures 211 can be formed on the second surface 21.

The metallic ink layer 30 is formed on the second surface 21 and fully covers the second surface 21. The metallic ink layer 30 includes a third surface 31. The third surface 31 faces away from the second surface 21.

The shading ink layer 40 is formed on the third surface 31.

The shading ink layer 40 fully covers the third surface 31 so as to enhance a color saturation of the metallic ink layer 30.

FIG. 2 illustrates a flowchart of a method for manufacturing a decoration of a metallic appearance 100 for article. The method is provided by way of example, as there are a variety of ways to carry out the method. The method described below can be carried out using the configurations illustrated in FIGS. 1 and 3-5, for example, and various elements of these figures are referenced in explaining example method. Each block shown in FIG. 2 represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 601.

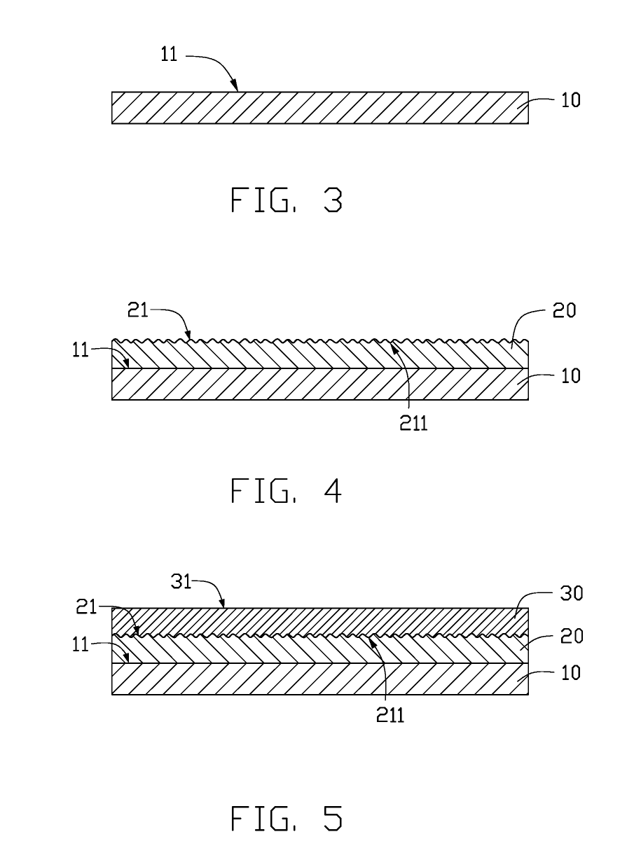

At block 601, also illustrated by FIG. 3, a transparent base layer 10 is provided. The base layer 10 includes a first surface 11.

The base layer 10 can be made by a material selected from a group consisting of polycarbonate, polyethylene terephthalate, polymethylmethacrylate, and any combination thereof.

In at least one exemplary embodiment, the base layer 10 is made by polycarbonate.

At block 602, also illustrated by FIG. 4, a texture layer 20 is formed on the first surface 111.

The texture layer 20 includes a second surface 21. The second surface 21 faces away from the first surface 11. A number of textures 211 can be formed on the second surface 21.

The textures 211 on the second surface 21 can be formed by hot-pressing, ultraviolet light stamping, or out-mold decoration.

In at least one exemplary embodiment, the texture layer 20 is made by out-mold decoration.

At block 603, also illustrated by FIG. 5, a metallic ink layer 30 is formed on the second surface 21.

The metallic ink layer 30 includes a third surface 31. The third surface 31 faces away from the second surface 21.

The metallic ink layer 30 fully covers the second surface 21.

The metallic ink layer is made of an UV-curable metallic ink.

The metallic ink layer 30 can be formed by printing or non-conductive vacuum metallization (NCVM).

In at least one exemplary embodiment, the metallic ink layer 30 is formed by NCVM.

In other exemplary embodiments, the metallic ink layer 30 can be formed by silk-screen printing using UV-curable metallic ink.

At block 604, also illustrated by FIG. 1, a shading ink layer 40 is formed on the third surface 31, thereby obtaining the decorative article 100.

In at least one exemplary embodiment, the shading ink layer 40 fully covers the third surface 31, so as to improve a color saturation of the metallic ink layer 30.

The shading ink layer 40 can be formed by printing.

In at least one exemplary embodiment, the shading ink layer 40 can be made of a material selected for a light shading ability.

At block 604, the decoration of a metallic appearance 100 is shaped by hot-bending or punching to obtain a desired shape.

With the above configuration, since the metallic ink layer 30 has a metallic appearance and the texture layer 20 has a number of textures 211, the decoration of a metallic appearance 100 has a metallic appearance. Furthermore, the shading ink layer 40 can improve the color saturation and apparent depth of the metallic ink layer 30.

The embodiments shown and described above are only examples. Therefore, many such details are neither shown nor described. Even though numerous characteristics and advantages of the present technology have been positioned forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims. It will therefore be appreciated that the embodiments described above can be modified within the scope of the claims.

What is claimed is:

1. A decoration of a metallic appearance for article comprising:
a base layer, the base layer comprising a first surface;
a texture layer, the texture layer formed on the first surface, the texture layer comprising a second surface facing away from the first surface, the texture layer further comprising a plurality of textures on the second surface; and
a metallic ink layer, the metallic ink layer formed on the second surface, the metallic ink layer fully covering the second surface.

2. The decorative article of claim 1, further comprising a shading ink layer, wherein the metallic ink layer comprises a third surface facing away from the second surface, and the shading ink layer is formed on the third surface.

3. The decorative article of claim 2, wherein the shading ink layer fully covers the third surface.

4. The decorative article of claim 1, wherein the base layer is transparent.

5. A method for manufacturing a decorative article with a metallic appearance, the method comprising:
providing a base layer, the base layer comprising a first surface;
forming a texture layer on the first surface, the texture layer comprising a second surface facing away from the first surface, the texture layer further comprising a plurality of textures on the second surface; and
forming a metallic ink layer on the second surface, the metallic ink layer fully covering the second surface.

6. The method of claim 5, wherein the texture layer is formed by hot-pressing, ultraviolet light stamping, out-mold decoration, or a combination thereof.

7. The method of claim 5, wherein, the metallic ink layer is formed by printing nonconductive vacuum metallization, or a combination thereof.

8. The method of claim 5, wherein the metallic ink layer is made of an UV-curable metallic ink.

9. The method of claim 8, wherein the metallic ink layer is formed by silk-screen printing using UV-curable metallic ink.

10. The method of claim 8, further comprising:
providing a shading ink layer and forming the shading ink layer on a third surface of the metallic ink layer facing away from the second surface.

11. The method of claim 10, wherein the shading ink layer fully covers the third surface.

12. The method of claim 10, wherein the shading ink layer is formed by printing.

13. The method of claim 10, further comprising:
shaping the decorative article by hot-bending, punching, or a combination thereof.
